(19) United States
(12) Patent Application Publication
(10) Pub. No.: US 2021/0201138 A1
(43) Pub. Date: Jul. 1, 2021

(54) LEARNING DEVICE, INFORMATION PROCESSING SYSTEM, LEARNING METHOD, AND LEARNING PROGRAM

(71) Applicant: NEC Corporation, Minato-ku, Tokyo (JP)

(72) Inventor: Ryota HIGA, Tokyo (JP)

(73) Assignee: NEC Corporation, Minato-ku, Tokyo (JP)

(21) Appl. No.: 17/057,394

(22) PCT Filed: May 25, 2018
(86) PCT No.: PCT/JP2018/020185

§ 371 Date: Nov. 20, 2020

(51) Int. Cl. G06N 3/08; G06N 3/04

(52) U.S. Cl. CPC G06N 3/08; G06N 3/0445

(57) ABSTRACT

A model setting unit 81 sets, as a problem setting to be targeted in reinforcement learning, a model in which a policy for determining an action to be taken in an environmental state is associated with a Boltzmann distribution representing a probability distribution of a prescribed state, and a reward function for determining a reward obtainable from an environmental state and an action selected in the state is associated with a physical equation representing a physical quantity corresponding to an energy. A parameter estimation unit 82 estimates parameters of the physical equation by performing the reinforcement learning using learning data including the state based on the set model.

### TECHNICAL FIELD

The present invention relates to a learning device, an information processing system, a learning method, and a learning program for learning a model that estimates a system mechanism.

### BACKGROUND ART

Various algorithms for machine learning have been proposed in the field of artificial intelligence (AI). A data assimilation technique is a method of reproducing phenomena using a simulator. For example, the technique uses a numerical model to reproduce highly nonlinear natural phenomena. Other machine learning algorithms, such as deep learning, are also used to determine parameters of a large-scale simulator or to extract features.

For an agent that performs actions in an environment where states can change, reinforcement learning is known as a way of learning an appropriate action according to the environmental state. For example, Non Patent Literature (NPL) 1 describes a method for efficiently performing the reinforcement learning by adopting domain knowledge of statistical mechanics.

### CITATION LIST

### Non Patent Literature

NPL 1: Adam Lipowski, et al., “Statistical mechanics approach to a reinforcement learning model with memory”, Physica A vol. 388, pp. 1849-1856, 2009

### SUMMARY OF INVENTION

### Technical Problem

Many AIs need to define clear goals and evaluation criteria before preparing data. For example, while it is necessary to define a reward according to an action and a state in the reinforcement learning, the reward cannot be defined unless the fundamental mechanism is known. That is, common AIs can be said to be, not data-driven, but goal/evaluation method-driven.

Specifically, for determining the parameters of a large-scale simulator as described above, it is necessary to determine the goal, and in the data assimilation technique, the existence of the simulator is the premise. In feature extraction using deep learning, although it may be possible to determine which feature is effective, learning the same in itself requires certain evaluation criteria. The same applies to the method described in NPL 1.

While many data items have been available in recent years, it is difficult to determine the goals and evaluation methods of systems having nontrivial mechanisms. It is therefore desired that, even in the case of a mechanism of a system representing a nontrivial phenomenon, the mechanism can be estimated in a data-driven manner.

In view of the foregoing, it is an object of the present invention to provide a learning device, an information processing system, a learning method, and a learning program capable of learning a model that estimates a system mechanism based on acquired data even if the mechanism is nontrivial.

### Solution to Problem

A learning device according to the present invention includes: a model setting unit that sets, as a problem setting to be targeted in reinforcement learning, a model in which a policy for determining an action to be taken in an environmental state is associated with a Boltzmann distribution representing a probability distribution of a prescribed state, and a reward function for determining a reward obtainable from an environmental state and an action selected in the state is associated with a physical equation representing a physical quantity corresponding to an energy; and a parameter estimation unit that estimates parameters of the physical equation by performing the reinforcement learning using learning data including the state based on the set model.

An information processing system according to the present invention includes: a model setting unit that sets, as a problem setting to be targeted in reinforcement learning, a model in which a policy for determining an action to be taken in an environmental state is associated with a Boltzmann distribution representing a probability distribution of a prescribed state, and a reward function for determining a reward obtainable from an environmental state and an action selected in the state is associated with a physical equation representing a physical quantity corresponding to an energy; a parameter estimation unit that estimates parameters of the physical equation by performing the reinforcement learning using learning data including the state based on the set model; a state estimation unit that estimates a state from an input action by using the estimated physical equation; and an imitation learning unit that performs imitation learning based on the input action and the estimated state.

A learning method according to the present invention includes: setting, by a computer, as a problem setting to be targeted in reinforcement learning, a model in which a policy for determining an action to be taken in an environmental state is associated with a Boltzmann distribution representing a probability distribution of a prescribed state, and a reward function for determining a reward obtainable from an environmental state and an action selected in the state is associated with a physical equation representing a physical quantity corresponding to an energy; and estimating, by the computer, parameters of the physical equation by performing the reinforcement learning using learning data including the state based on the set model.

A learning program according to the present invention causes a computer to perform: model setting processing of setting, as a problem setting to be targeted in reinforcement learning, a model in which a policy for determining an action to be taken in an environmental state is associated with a Boltzmann distribution representing a probability distribution of a prescribed state, and a reward function for determining a reward obtainable from an environmental state and an action selected in the state is associated with a physical equation representing a physical quantity corresponding to an energy; and parameter estimation processing of estimating parameters of the physical equation by performing the reinforcement learning using learning data including the state based on the set model.

### Advantageous Effects of Invention

The present invention enables learning a model that estimates a system mechanism based on acquired data even if the mechanism is nontrivial.

### BRIEF DESCRIPTION OF DRAWINGS

FIG. 1 It is a block diagram depicting an exemplary embodiment of an information processing system including a learning device according to the present invention.

FIG. 2 It depicts an example of processing of generating a physical simulator.

FIG. 3 It is a flowchart illustrating an exemplary operation of the learning device.

FIG. 4 It is a flowchart illustrating an exemplary operation of the information processing system.

FIG. 5 It depicts an example of a physical simulator of an inverted pendulum.

FIG. 6 It is a block diagram depicting an outline of a learning device according to the present invention.

FIG. 7 It is a block diagram depicting an outline of an information processing system according to the present invention.

FIG. 8 It is a schematic block diagram depicting a configuration of a computer according to at least one exemplary embodiment.

### DESCRIPTION OF EMBODIMENT

Exemplary embodiments of the present invention will be described below with reference to the drawings.

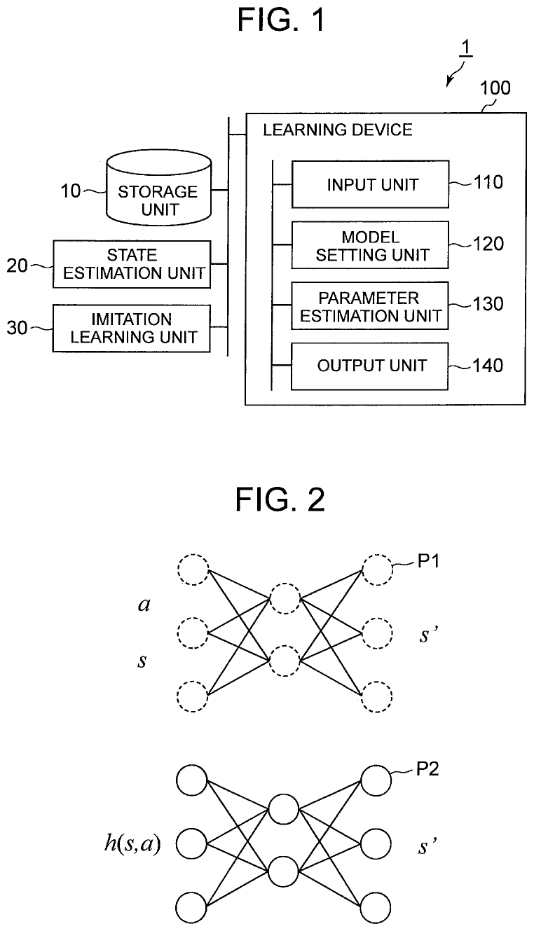

FIG. 1 is a block diagram depicting an exemplary embodiment of an information processing system including a learning device according to the present invention. An information processing system 1 of the present exemplary embodiment includes a storage unit 10, a learning device 100, a state estimation unit 20, and an imitation learning unit 30.

The storage unit 10 stores data (hereinafter, referred to as learning data) that associates a state vector s=(s₁, s₂, . . . ) representing the state of a target environment with an action a performed in the state represented by the state vector. Assumed here are, as in general reinforcement learning, an environment (hereinafter, referred to as target environment) in which more than one state can be taken and a subject (hereinafter, referred to as agent) that can perform more than one action in the environment. In the following description, the state vector s may simply be denoted as state s.

Examples of the agent include a self-driving car. The target environment in this case is represented as a collection of states of the self-driving car and its surroundings (e.g., surrounding maps, other vehicle positions and speeds, and road states).

The action to be performed by the agent varies depending on the state of the target environment. In the case of the self-driving car described above, it is necessary to proceed to avoid any obstacle existing in front. It is also necessary to change the driving speed of the vehicle according to the state of the road surface ahead, the distance between the vehicle and the vehicle ahead, and so on.

A function that outputs an action to be performed by the agent according to the state of the target environment is called a policy. The imitation learning unit 30, which will be described below, generates a policy by imitation learning. If the policy is learned to be ideal, the policy will output an optimal action to be performed by the agent according to the state of the target environment.

The imitation learning unit 30 performs imitation learning using data that associates a state vector s with an action a (i.e., the learning data) to output a policy. The policy obtained by the imitation learning is to imitate the given learning data. Here, the policy according to which an agent selects an action is represented as π, and the probability that an action a is selected in a state s under the policy π is represented as π(s, a). The way for the imitation learning unit 30 to perform imitation learning is not limited. The imitation learning unit 30 may use a general method to perform imitation learning to thereby output a policy.

Further, the imitation learning unit 30 performs imitation learning to output a reward function. Specifically, the imitation learning unit 30 defines a policy which has, as an input to a function, a reward r(s) obtained by inputting a state vector s into a reward function r. That is, an action a obtained from the policy is defined by the expression 1 illustrated below.

a˜π(a|r(s)) (Expression 1)

That is, the imitation learning unit 30 may formulate the policy as a functional of a reward function. By performing the imitation learning using such a formulated policy, the imitation learning unit 30 can also learn the reward function while learning the policy.

The probability that a state s′ is selected based on a certain state s and action a can be expressed as π(a|s). When a policy is defined as in the expression 1 shown above, a reward function r(s, a) can be used to define a relationship of the expression 2 illustrated below. It should be noted that the reward function r(s, a) may also be denoted as rₐ(s).

γc(a|s):=γc(a|r(s,a)) (Expression 2)

The imitation learning unit 30 may learn the reward function r(s, a) by using a function formulated as in the expression 3 illustrated below. In the expression 3, λ′ and θ′ are parameters determined by the data, and g′(θ′) is a regularization term.

$$\begin{matrix}[ Math . 1 ] & \\ r ( s , a ) := {\sum }_{i}^{N} {θ}_{i}^{′} {s}_{i} + {\sum }_{j = N + 1} {θ}_{j}^{′} {a}_{j} + {λ}^{′} {g}^{′} ( {θ}^{′} ) & ( Expression 3 )\end{matrix}$$

The probability π(a|s) for the policy to be selected relates to the reward obtainable from an action a in a certain state s, so it can be defined using the above reward function rₐ(s) in the form of the expression 4 illustrated below. It should be noted that Z_{R} is a partition function, and Z_{R}=Σₐexp(rₐ(s)).

$$\begin{matrix}[ Math . 2 ] & \\ ( a \vert s ) := \frac{exp ( {r}_{a} ( s ) )}{{Z}_{R}} & ( Expression 4 )\end{matrix}$$

The learning device 100 includes an input unit 110, a model setting unit 120, a parameter estimation unit 130, and an output unit 140.

The input unit 110 inputs learning data stored in the storage unit 10 into the parameter estimation unit 130.

The model setting unit 120 models a problem to be targeted in reinforcement learning which is performed by the parameter estimation unit 130 as will be described later. Specifically, in order for the parameter estimation unit 130, described later, to estimate parameters of a function by the reinforcement learning, the model setting unit 120 determines a rule of the function to be estimated.

Meanwhile, as indicated by the expression 4 above, it can be said that the policy π representing an action a to be taken in a certain state s has a relationship with the reward function r(s, a) for determining a reward r obtainable from a certain environmental state s and an action a selected in that state. Reinforcement learning is for finding an appropriate policy π through learning in consideration of the relationship.

On the other hand, the present inventor has realized that the idea of finding a policy π based on the state s and the action a in the reinforcement learning can be used to find a nontrivial system mechanism based on a certain phenomenon. As used herein, the system is not limited to a system that is mechanically configured, but also includes any system that exists in nature.

A specific example representing a probability distribution of a certain state is the Boltzmann distribution (Gibbs distribution) in statistical mechanics. From the standpoint of the statistical mechanics as well, when an experiment is conducted based on certain experimental data, a certain energy state occurs based on a prescribed mechanism, so this energy state is considered to correspond to a reward in the reinforcement learning.

In other words, it can be said that the above content explains that, similarly as in the reinforcement learning in which a policy can be estimated because a certain reward has been determined, in the statistical mechanics, an energy distribution can be estimated because a certain equation of motion has been determined. One reason why the relationships are associated in the above-described manner is that they are connected by the concept of entropy.

Generally, the energy state can be represented by a physical equation (e.g., a Hamiltonian) representing the physical quantity corresponding to the energy. Thus, the model setting unit 120 provides a problem setting for the function to be estimated in reinforcement learning, so that the parameter estimation unit 130, described later, can estimate the Boltzmann distribution in the statistical mechanics in the framework of the reinforcement learning.

Specifically, as a problem setting to be targeted in the reinforcement learning, the model setting unit 120 associates a policy π(a|s) for determining an action a to be taken in an environmental state s, with a Boltzmann distribution representing a probability distribution of a prescribed state. Furthermore, as the problem setting to be targeted in the reinforcement learning, the model setting unit 120 associates a reward function r(s, a) for determining a reward r obtainable from an environmental state s and an action selected in that state, with a physical equation (a Hamiltonian) representing a physical quantity corresponding to an energy. In this manner, the model setting unit 120 models the problem to be targeted by the reinforcement learning.

Here, when the Hamiltonian is represented as H, generalized coordinates as q, and generalized momentum as p, then the Boltzmann distribution f(q, p) can be represented by the expression 5 illustrated below. In the expression 5, β is a parameter representing a system temperature, and Z_{S} is a partition function.

$$\begin{matrix}[ Math . 3 ] & \\ f ( q , p ) = \frac{exp ( - β H ( q , p ) )}{{Z}_{S}} & ( Expression 5 )\end{matrix}$$

As compared with the expression 4 shown above, it can be said that the Boltzmann distribution in the expression 5 corresponds to the policy in the expression 4, and the Hamiltonian in the expression 5 corresponds to the reward function in the expression 4. In other words, it can be said, from the correspondence between the above expressions 4 and 5 as well, that the Boltzmann distribution in the statistical mechanics has been modeled successfully in the framework of the reinforcement learning.

A description will now be made about a specific example of a physical equation (Hamiltonian, Lagrangian, etc.) to be associated with a reward function r(s, a). For a state transition probability based on a physical equation h(s, a), a formula indicated by the expression 6 below holds.

p(s′|s,a)=p(s′|h(s,a)) (Expression 6)

The right side of the expression 6 can be defined as in the expression 7 shown below. In the expression 7, Z_{S} is a partition function, and Z_{S}=Σ_{S′}exp(h_{s′}(s, a)).

$$\begin{matrix}[ Math . 4 ] & \\ p ( {s}^{′} \vert h ( s , a ) ) := \frac{exp ( {h}_{{s}^{′}} ( s , a ) )}{{Z}_{S}} & ( Expression 7 )\end{matrix}$$

When h(s, a) is given a condition that satisfies the law of physics, such as time reversal, space inversion, or quadratic form, then the physical equation h(s, a) can be defined as in the expression 8 shown below. In the expression 8, λ and θ are parameters determined by data, and g(θ) is a regularization term.

$$\begin{matrix}[ Math . 5 ] & \\ h ( s , a ) = {\sum }_{i , j}^{N} {θ}_{i} {s}_{i} {s}_{j} + {\sum }_{k = 2 N + 1}^{ } {θ}_{k} {a}_{k} + λ g ( θ ) & ( Expression 8 )\end{matrix}$$

Some energy states do not require actions. The model setting unit 120 can also express a state that involves no action, by setting an equation of motion in which an effect attributed to an action a and an effect attributed to a state s independent of the action are separated from each other, as shown in the expression 8.

Furthermore, as compared with the expression 3 shown above, each term of the equation of motion in the expression 8 can be associated with each term of the reward function in the expression 3. Thus, using the method of learning a reward function in the framework of the reinforcement function enables estimation of a physical equation. In this manner, the model setting unit 120, by performing the above-described processing, can design a model (specifically, a cost function) that is needed for learning by the parameter estimation unit described below.

The parameter estimation unit 130 estimates parameters of a physical equation by performing reinforcement learning using learning data including states s, based on the model set by the model setting unit 120. There are cases where an energy state does not need to involve an action, as described previously, so the parameter estimation unit 130 performs the reinforcement learning using learning data that includes at least states s. The parameter estimation unit 130 may estimate the parameters of a physical equation by performing the reinforcement learning using learning data that includes both states s and actions a.

For example, when a state of the system observed at time t is represented as sₜ and an action as aₜ, the data can be said to be a time series operational data set Dₜ={sₜ, aₜ} representing the action and operation on the system. In addition, estimating the parameters of the physical equation provides information simulating the behavior of the physical phenomenon, so it can also be said that the parameter estimation unit 130 generates a physical simulator.

The parameter estimation unit 130 may use a neural network, for example, to generate a physical simulator. FIG. 2 is a diagram depicting an example of processing of generating a physical simulator. A perceptron P1 illustrated in FIG. 2 shows that a state s and an action a are input to an input layer and a next state s′ is output at an output layer, as in a general method. On the other hand, a perceptron P2 illustrated in FIG. 2 shows that a simulation result h(s, a) determined according to a state s and an action a is input to the input layer and a next state s′ is output at the output layer.

Learning as in the perceptrons illustrated in FIG. 2 makes it possible to achieve formulation including an operator and obtain a time evolution operator, thereby enabling new theoretical proposal as well.

The parameter estimation unit 130 may also estimate the parameters by performing maximum likelihood estimation of a Gaussian mixture distribution.

The parameter estimation unit 130 may also use a product model and a maximum entropy method to generate a physical simulator. Specifically, a formula defined by the expression 9 illustrated below may be formulated as a functional of a physical equation h, as shown in the expression 10, to estimate the parameters. Performing the formulation shown in the expression 10 enables learning a physical simulator that depends on an operation (i.e., a≠0).

$$\begin{matrix}[ Math . 6 ] & \\ {∇}_{θ} {ln p}_{θ} ( {s}^{′} \vert s , a ) = 0 & ( Expression 9 ) \\ \frac{δ}{δ h} ln p ( {s}^{′} \vert h ( s , a ) ) = 0 & ( Expression 10 )\end{matrix}$$

As described previously, the model setting unit 120 has associated a reward function r(s, a) with a physical equation h(s, a), so the parameter estimation unit 130 can estimate a Boltzmann distribution as a result of estimating the physical equation using a method of estimating the reward function. That is, providing a formulated function as a problem setting for reinforcement learning makes it possible to estimate the parameters of an equation of motion in the framework of the reinforcement learning.

Further, with the equation of motion being estimated by the parameter estimation unit 130, it also becomes possible to extract a rule for a physical phenomenon or the like from the estimated equation of motion or to update the existing equation of motion.

The output unit 140 outputs the equation of motion with its parameters estimated, to the state estimation unit 20 and the imitation learning unit 30.

The state estimation unit 20 estimates a state from an action based on the estimated equation of motion. That is, the state estimation unit 20 operates as a physical simulator.

The imitation learning unit 30 performs imitation learning using an action and a state that the state estimation unit 20 has estimated based on that action, and may further perform processing of estimating a reward function.

The learning device 100 (more specifically, the input unit 110, the model setting unit 120, the parameter estimation unit 130, and the output unit 140), the state estimation unit 20, and the imitation learning unit 30 are implemented by a processor (e.g., a central processing unit (CPU), a graphics processing unit (GPU), a field-programmable gate array (FPGA)) of a computer that operates in accordance with a program (the learning program).

For example, the program may be stored in a storage unit (not shown) included in the information processing system 1, and the processor may read the program and operate as the learning device 100 (more specifically, the input unit 110, the model setting unit 120, the parameter estimation unit 130, and the output unit 140), the state estimation unit 20, and the imitation learning unit 30 in accordance with the program. Further, the functions of the information processing system 1 may be provided in the form of Software as a Service (SaaS).

The learning device 100 (more specifically, the input unit 110, the model setting unit 120, the parameter estimation unit 130, and the output unit 140), the state estimation unit 20, and the imitation learning unit 30 may each be implemented by dedicated hardware. Further, some or all of the components of each device may be implemented by general purpose or dedicated circuitry, processors, etc., or combinations thereof. They may be configured by a single chip or a plurality of chips connected via a bus. Some or all of the components of each device may be implemented by a combination of the above-described circuitry or the like and the program.

Further, when some or all of the components of the information processing system 1 are realized by a plurality of information processing devices or circuits, the information processing devices or circuits may be disposed in a centralized or distributed manner. For example, the information processing devices or circuits may be implemented in the form of a client server system, a cloud computing system, or the like, in which the devices or circuits are connected via a communication network.

Further, the storage unit 10 is implemented by, for example, a magnetic disk or the like.

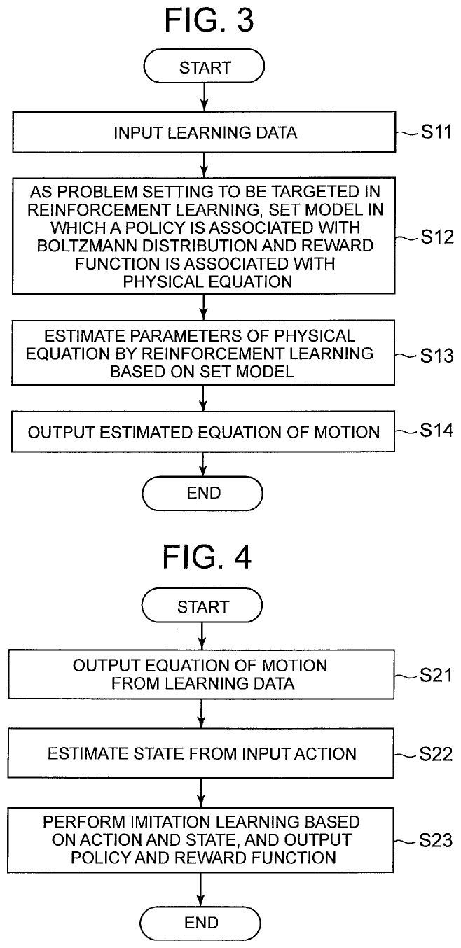

An operation of the learning device 100 of the present exemplary embodiment will now be described. FIG. 3 is a flowchart illustrating an exemplary operation of the learning device 100 of the present exemplary embodiment. The input unit 110 inputs learning data which is used by the parameter estimation unit 130 for learning (step S11). The model setting unit 120 sets, as a problem setting to be targeted in reinforcement learning, a model in which a policy is associated with a Boltzmann distribution and a reward function is associated with a physical equation (step S12). It should be noted that the model setting unit 120 may set the model before the learning data is input (i.e., prior to step S11).

The parameter estimation unit 130 estimates parameters of the physical equation by the reinforcement learning, based on the set model (step S13). The output unit 140 outputs an equation of motion represented by the estimated parameters (step S14).

Next, an operation of the information processing system 1 of the present exemplary embodiment will be described. FIG. 4 is a flowchart illustrating an exemplary operation of the information processing system 1 of the present exemplary embodiment. The learning device 100 outputs an equation of motion from learning data, by the processing illustrated in FIG. 3 (step S21). The state estimation unit 20 uses the output equation of motion to estimate a state s from an input action a (step S22). The imitation learning unit 30 performs imitation learning based on the input action a and the estimated state s, to output a policy and a reward function (step S23).

As described above, in the present exemplary embodiment, the model setting unit 120 sets, as a model setting to be targeted in reinforcement learning, a model in which a policy is associated with a Boltzmann distribution and a reward function is associated with a physical equation, and the parameter estimation unit 130 estimates parameters of the physical equation by performing the reinforcement learning based on the set model. Accordingly, it is possible to learn a model that estimates a system mechanism (specifically, equation of motion) based on acquired data even if the mechanism is nontrivial.

Further, the state estimation unit 20 uses the physical equation, estimated based on the data, to estimate a state s from an input action a, and the imitation learning unit 30 performs imitation learning based on the input action a and the estimated state s, to output a policy and a reward function. Therefore, even in the case of a mechanism of a system that represents a nontrivial phenomenon, the mechanism can be estimated in a data-driven manner.

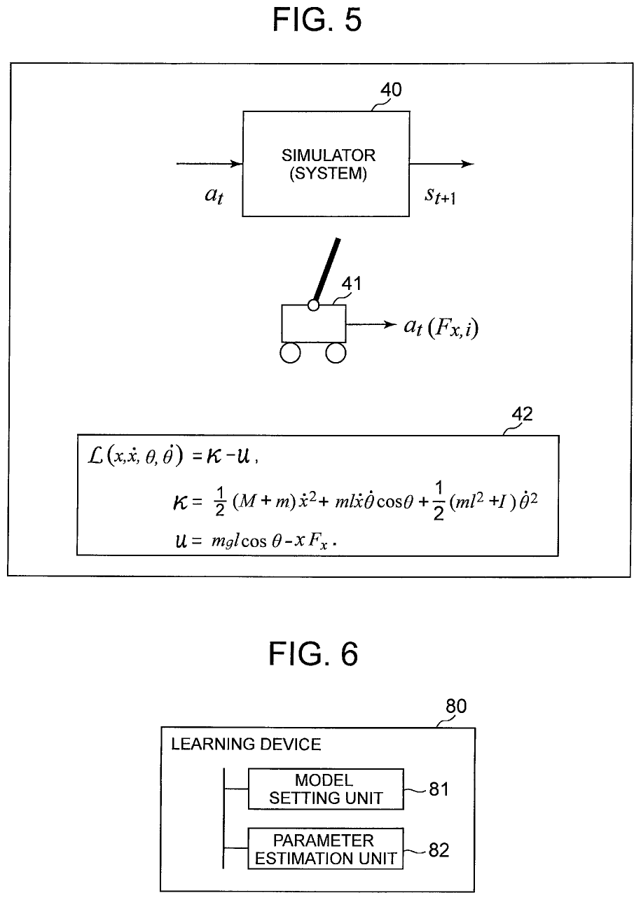

A specific example of the present invention will now be described with a method of estimating an equation of motion for an inverted pendulum. FIG. 5 is a diagram depicting an example of a physical simulator of an inverted pendulum. The simulator (system) 40 illustrated in FIG. 5 estimates a next state sₜ₊₁ with respect to an action aₜ of the inverted pendulum 41 at a certain time t. Although the equation 42 of motion of the inverted pendulum is known as illustrated in FIG. 5, it is here assumed that the equation 42 of motion is unknown.

A state sₜ at time t is represented by the expression 11 shown below.

[Math. 7]

sₜ={xₜ,\dot{x}ₜ,θₜ,\dot{θ}ₜ} (Express on 11)

For example, suppose that the data illustrated in the expression 12 below has been observed as the action (operation) of the inverted pendulum.

$$\begin{matrix}[ Math . 8 ] & \\ \\ {x}_{i + 1} = {x}_{i} + τ {\dot{x}}_{i} \\ {\dot{x}}_{i + 1} = {\dot{x}}_{i} + τ {\ddot{x}}_{i} \\ {θ}_{i + 1} = {θ}_{i} + τ {\dot{θ}}_{i} \\ {\dot{θ}}_{i + 1} = {\dot{θ}}_{i} + τ {\ddot{θ}}_{i} . \\ Δ t := τ > 0 \\ {\ddot{x}}_{i} = {T}_{i} - \frac{ml {\ddot{θ}}_{i}}{M + m} {cos θ}_{i} \\ {T}_{i} := \frac{{F}_{x , i} + {mlθ}_{i} {sin θ}_{i}}{M + m} \\ {\ddot{θ}}_{i} = \frac{{g sin θ}_{i} - {T}_{i} {cos θ}_{i}}{\frac{4}{3} l - \frac{{ml cos}^{2} {θ}_{i}}{M + m}} & ( Expression 12 )\end{matrix}$$

Here, the model setting unit 120 sets the equation of motion of the expression 8 shown above, and the parameter estimation unit 130 performs reinforcement learning based on the observed data shown in the above expression 12, whereby the parameters of h(s, a) shown in the expression 8 can be learned. The equation of motion learned in this manner represents a preferable operation in a certain state, so it can be said to be close to a system representing the motion of the inverted pendulum. By learning in this way, it is possible to estimate the system mechanism even if the equation of motion is unknown.

In addition to the inverted pendulum described above, a harmonic oscillator or a pendulum, for example, is also effective as a system the operation of which can be confirmed.

An outline of the present invention will now be described. FIG. 6 is a block diagram depicting an outline of a learning device according to the present invention. The learning device 80 according to the present invention (e.g., the learning device 100) includes: a model setting unit 81 (e.g., the model setting unit 120) that sets, as a problem setting to be targeted in reinforcement learning, a model in which a policy for determining an action to be taken in an environmental state is associated with a Boltzmann distribution representing a probability distribution of a prescribed state, and a reward function for determining a reward obtainable from an environmental state and an action selected in the state is associated with a physical equation representing a physical quantity corresponding to an energy; and a parameter estimation unit 82 (e.g., the parameter estimation unit 130) that estimates parameters of the physical equation by performing the reinforcement learning using learning data including the state (e.g., the state vector s) based on the set model.

Such a configuration enables learning a model that estimates a system mechanism based on acquired data even if the mechanism is nontrivial.

The parameter estimation unit 82 may estimate the parameters of the physical equation by performing the reinforcement learning using learning data including the state and the action, based on the set model. Such a configuration allows estimation of the physical equation including the action (operation) as well.

The model setting unit 81 may set a physical equation (e.g., the equation of motion shown in the expression 8 above) having an effect attributable to the action and an effect attributable to the state separated from each other.

Specifically, the model setting unit 81 may set the model having the reward function associated with a Hamiltonian.

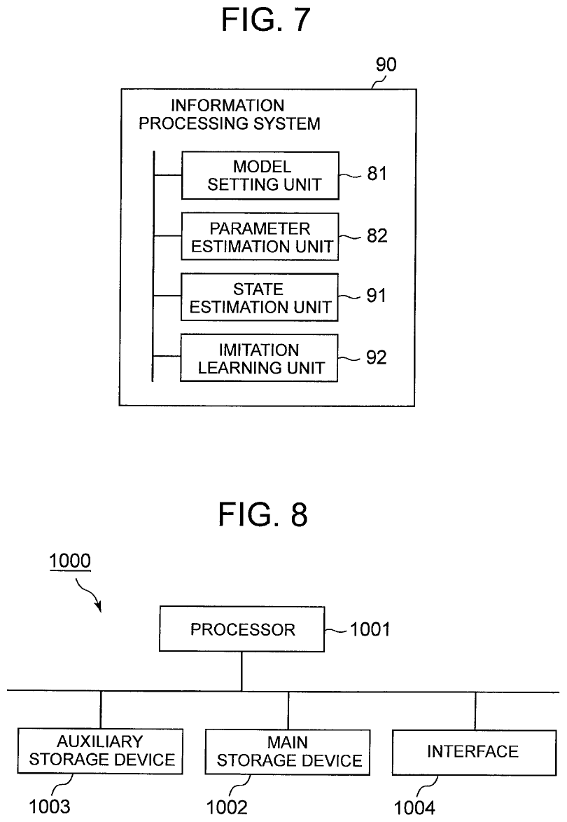

FIG. 7 is a block diagram depicting an outline of an information processing system according to the present invention. The information processing system 90 according to the present invention includes: a model setting unit 81 (e.g., the model setting unit 120); a parameter estimation unit 82 (e.g., the parameter estimation unit 130); a state estimation unit 91 (e.g., the state estimation unit 20) that estimates a state from an input action by using the estimated physical equation; and an imitation learning unit 92 (e.g., the imitation learning unit 30) that performs imitation learning based on the input action and the estimated state. The contents of the model setting unit 81 and the parameter estimation unit 82 are identical to the configuration included in the learning device 80 illustrated in FIG. 6.

Such a configuration also enables learning a model that estimates a system mechanism based on acquired data even if the mechanism is nontrivial.

FIG. 8 is a schematic block diagram depicting a configuration of a computer according to at least one exemplary embodiment. The computer 1000 includes a processor 1001, a main storage device 1002, an auxiliary storage device 1003, and an interface 1004.

The learning device 80 and the information processing system 90 described above are implemented in a computer 1000. The operations of each processing unit described above are stored in the auxiliary storage device 1003 in the form of a program (the learning program). The processor 1001 reads the program from the auxiliary storage device 1003 and deploys the program to the main storage device 1002 to perform the above-described processing in accordance with the program.

In at least one exemplary embodiment, the auxiliary storage device 1003 is an example of a non-transitory tangible medium. Other examples of the non-transitory tangible medium include a magnetic disk, magneto-optical disk, compact disc read-only memory (CD-ROM), DVD read-only memory (DVD-ROM), semiconductor memory, and the like, connected via the interface 1004. In the case where the program is delivered to the computer 1000 via a communication line, the computer 1000 receiving the delivery may deploy the program to the main storage device 1002 and perform the above-described processing.

In addition, the program may be for implementing a part of the functions described above. Further, the program may be a so-called differential file (differential program) that realizes the above-described functions in combination with another program already stored in the auxiliary storage device 1003.

Some or all of the above exemplary embodiments may also be described as, but not limited to, the following supplementary notes.

(Supplementary note 1) A learning device comprising: a model setting unit configured to set, as a problem setting to be targeted in reinforcement learning, a model in which a policy for determining an action to be taken in an environmental state is associated with a Boltzmann distribution representing a probability distribution of a prescribed state, and a reward function for determining a reward obtainable from an environmental state and an action selected in the state is associated with a physical equation representing a physical quantity corresponding to an energy; and a parameter estimation unit configured to estimate parameters of said physical equation by performing the reinforcement learning using learning data including said state based on said set model.

(Supplementary note 2) The learning device according to supplementary note 1, wherein the parameter estimation unit estimates the parameters of the physical equation by performing the reinforcement learning using the learning data including the state and the action based on the set model.

(Supplementary note 3) The learning device according to supplementary note 1 or 2, wherein the model setting unit sets the physical equation having an effect attributable to the action and an effect attributable to the state separated from each other.

(Supplementary note 4) The learning device according to any one of supplementary notes 1 to 3, wherein the model setting unit sets the model having the reward function associated with a Hamiltonian.

(Supplementary note 5) An information processing system comprising: a model setting unit configured to set, as a problem setting to be targeted in reinforcement learning, a model in which a policy for determining an action to be taken in an environmental state is associated with a Boltzmann distribution representing a probability distribution of a prescribed state, and a reward function for determining a reward obtainable from an environmental state and an action selected in the state is associated with a physical equation representing a physical quantity corresponding to an energy; a parameter estimation unit configured to estimate parameters of said physical equation by performing the reinforcement learning using learning data including said state based on said set model; a state estimation unit configured to estimate a state from an input action by using the estimated physical equation; and an imitation learning unit configured to perform imitation learning based on said input action and the estimated state.

(Supplementary note 6) A learning method comprising: setting, by a computer, as a problem setting to be targeted in reinforcement learning, a model in which a policy for determining an action to be taken in an environmental state is associated with a Boltzmann distribution representing a probability distribution of a prescribed state, and a reward function for determining a reward obtainable from an environmental state and an action selected in the state is associated with a physical equation representing a physical quantity corresponding to an energy; and estimating, by said computer, parameters of said physical equation by performing the reinforcement learning using learning data including said state based on said set model.

(Supplementary note 7) The learning method according to supplementary note 6, comprising: estimating, by the computer, the parameters of the physical equation by performing the reinforcement learning using the learning data including the state and the action based on the set model.

(Supplementary note 8) The learning method according to supplementary note 6 or 7, comprising: estimating, by the computer, a state from an input action by using the estimated physical equation; and performing, by said computer, imitation learning based on said input action and the estimated state.

(Supplementary note 9) A learning program causing a computer to perform: model setting processing of setting, as a problem setting to be targeted in reinforcement learning, a model in which a policy for determining an action to be taken in an environmental state is associated with a Boltzmann distribution representing a probability distribution of a prescribed state, and a reward function for determining a reward obtainable from an environmental state and an action selected in the state is associated with a physical equation representing a physical quantity corresponding to an energy; and parameter estimation processing of estimating parameters of said physical equation by performing the reinforcement learning using learning data including said state based on said set model.

(Supplementary note 10) The learning program according to supplementary note 9, causing the computer, in the parameter estimation processing, to estimate the parameters of the physical equation by performing the reinforcement learning using the learning data including the state and the action based on the set model.

(Supplementary note 11) A learning program causing a computer to perform: model setting processing of setting, as a problem setting to be targeted in reinforcement learning, a model in which a policy for determining an action to be taken in an environmental state is associated with a Boltzmann distribution representing a probability distribution of a prescribed state, and a reward function for determining a reward obtainable from an environmental state and an action selected in the state is associated with a physical equation representing a physical quantity corresponding to an energy; parameter estimation processing of estimating parameters of said physical equation by performing the reinforcement learning using learning data including said state based on said set model; state estimation processing of estimating a state from an input action using the estimated physical equation; and imitation learning processing of performing imitation learning based on said input action and the estimated state.

### REFERENCE SIGNS LIST

1 information processing system
10 storage unit
20 state estimation unit
30 imitation learning unit
100 learning device
110 input unit
120 model setting unit
130 parameter estimation unit
140 output unit

What is claimed is:

1. A learning device comprising a hardware processor configured to execute a software code to:
set, as a problem setting to be targeted in reinforcement learning, a model in which a policy for determining an action to be taken in an environmental state is associated with a Boltzmann distribution representing a probability distribution of a prescribed state, and a reward function for determining a reward obtainable from an environmental state and an action selected in the state is associated with a physical equation representing a physical quantity corresponding to an energy; and
estimate parameters of said physical equation by performing the reinforcement learning using learning data including said state based on said set model.

2. The learning device according to claim 1, wherein the hardware processor is configured to execute a software code to estimate the parameters of the physical equation by performing the reinforcement learning using the learning data including the state and the action based on the set model.

3. The learning device according to claim 1, wherein the hardware processor is configured to execute a software code to set the physical equation having an effect attributable to the action and an effect attributable to the state separated from each other.

4. The learning device according to claim 1, wherein the hardware processor is configured to execute a software code to set the model having the reward function associated with a Hamiltonian.

5. An information processing system comprising a hardware processor configured to execute a software code to:
set, as a problem setting to be targeted in reinforcement learning, a model in which a policy for determining an action to be taken in an environmental state is associated with a Boltzmann distribution representing a probability distribution of a prescribed state, and a reward function for determining a reward obtainable from an environmental state and an action selected in the state is associated with a physical equation representing a physical quantity corresponding to an energy;
estimate parameters of said physical equation by performing the reinforcement learning using learning data including said state based on said set model;
estimate a state from an input action by using the estimated physical equation; and
perform imitation learning based on said input action and the estimated state.

6. A learning method comprising:
setting, by a computer, as a problem setting to be targeted in reinforcement learning, a model in which a policy for determining an action to be taken in an environmental state is associated with a Boltzmann distribution representing a probability distribution of a prescribed state, and a reward function for determining a reward obtainable from an environmental state and an action selected in the state is associated with a physical equation representing a physical quantity corresponding to an energy; and
estimating, by said computer, parameters of said physical equation by performing the reinforcement learning using learning data including said state based on said set model.

7. The learning method according to claim 6, comprising:
estimating, by the computer, the parameters of the physical equation by performing the reinforcement learning using the learning data including the state and the action based on the set model.

8. The learning method according to claim 6, comprising:
estimating, by the computer, a state from an input action by using the estimated physical equation; and
performing, by said computer, imitation learning based on said input action and the estimated state.

9-11. (canceled)
